(19) United States
(12) Patent Application Publication
(10) Pub. No.: US 2009/0206121 A1
(43) Pub. Date: Aug. 20, 2009

(54) Power adjustable fastener propelling tool

(76) Inventor: Frank L. Araiza, Costa Mesa, CA (US)

Correspondence Address: STETINA BRUNDA GARRED & BRUCKER, 75 ENTERPRISE, SUITE 250, ALISO VIEJO, CA, 92656, US

(21) Appl. No.: 12/069,983

(22) Filed: Feb. 14, 2008

(51) Int. Cl. B25C 1/12

(52) U.S. Cl. 227/10; 227/120

(57) ABSTRACT

There is provided a fastening tool including a tool body and a combustion housing defining a combustion chamber. A barrel is connected to the combustion housing and includes a barrel opening configured to receive a fastener. The tool also includes a power source configured to generate a power source signal. A power regulator is in electrical communication with the power source and is configured to receive the power source signal and transmit a power regulator output having an output magnitude. A manual power control is in operative communication with the power regulator and is configured to adjust the power regulator output magnitude. A spark generator is in electrical communication with the power regulator and is configured to generate a spark within the combustion chamber upon receipt of the power output from the power regulator. The spark includes a spark magnitude that varies in response to the power output magnitude.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

1. Field of the Invention

The present invention relates generally to an improved fastening tool for use with a fastener, and more specifically to a fastening tool configured to provide a more efficient and user-friendly tool for various fastening applications.

2. Description of the Prior Art

It is well known in the art to use various types of fasteners to attach one item to another. This is especially true in the construction industry. For instance, fasteners may be used to connect one piece of framing material (e.g. metal or wood) to another piece of framing material. Another common application for fasteners includes securing drywall to the frame. Nails and screws are fasteners that are readily employed on construction projects. However, it is understood that various other fasteners may also be used in the art.

The use of a tool may be desirable to insert a fastener into a particular material. For instance, in the case of a nail, a hammer is typically used to drive the nail into the material. A user swings the hammer and strikes the head of the nail to drive the nail into the material. However, large constructions projects may require a significant amount of nails. Using a hammer to drive each nail into the material may take a long time. Furthermore, if a user swings and misses the nail, the hammer may damage the material (e.g., dent or break the material) or injure the user.

Screws are also commonly used in addition to nails. A typical screw includes a head, a shank, and threads disposed about the shank. A screwdriver may be used to insert the screw into the material. A user rotates the screwdriver, which in turn, rotates the screw. As the screw rotates, the screw enters the material.

One common usage of screws is for hanging drywall on the frame of a structure. Screws are preferably used over other fasteners because the threads of the screw engage with the frame to mitigate removal of the screw from the frame. Nails are typically not used because nails lack a pull force. In other words, if a nail is pulled after it is driven into the frame, the nail may be removed by pulling on it.

In most construction projects, it is generally important to be as efficient as possible without sacrificing the quality of the workmanship. Many projects are priced by the square foot of the project as opposed to the time it takes to complete it. Therefore, the profit generated on a particular project may be increased by completing the project in a shorter period of time. Construction projects completed using the manual fastening tools described above (e.g., hammer and screwdriver) tend to take long periods of time, which reduces the profit generated by the project. Therefore, several fastening tools were developed to increase the efficiency of construction projects.

To address this particular need, it is known in the prior art to employ the use of a nail gun to achieve increased efficiency. A typical nail gun includes an internal combustion chamber which creates a propelling force to drive the nail toward the fastening substrate. Gas may be communicated into the combustion chamber from a fuel source. Most nail guns include a removable fuel cartridge that supplies the gas. Once the gas is received in the combustion chamber, a spark may be created by a spark plug to ignite the gas, thereby creating the propelling force.

A piston may be driven by the propelling force to engage with a nail positioned within a firing barrel. A magazine or ribbon of nails may be connected to the gun to enable rapid reloading and firing of the nail gun. In this manner, the nail gun tends to provide a quicker and more efficient alternative to a conventional hammer. More nails may be propelled in a given period of time than can be driven by a hammer.

Although conventional nail guns may provide a more efficient alternative to a hammer, there may be several disadvantages associated with most fastening guns. One particular disadvantage may relate to the loading of the fuel cartridge. In most nail guns, the fuel cartridge is placed within a fuel chamber and aligned with a fuel valve. Once the fuel cartridge is placed within the fuel chamber, it may be difficult to maneuver the fuel cartridge to align it with the fuel valve. As such, additional time and energy may be spent on simply loading the fuel cartridge into the fuel chamber.

Another disadvantage may be associated with the propelling force created by the nail gun. More specifically, conventional nail guns are generally configured to create a constant propelling force. In other words, the combustion generated within the combustion chamber may be substantially the same when firing consecutive fasteners. Given that fastening tools are used to propel fasteners into a wide range of materials (e.g., wood, metal, etc.), it may be desirable to vary the propelling force depending on the material. For instance, a larger force may be required to propel a fastener into metal than wood.

In addition, typical fastening tools may not allow quick and easy variation of the momentum a fastener has when the fastener enters the fastening substrate. Such variation may be desirable if the tool is used in connection with various materials. For instance, since metal materials tend to be harder than wood materials, it may be advantageous to propel a fastener into the metal material with more momentum than would be propelled into the wood material.

A further disadvantage of existing fastening tools may relate to the triggering of the propelling force. Many fastening tools are designed to generate a propelling force when a nose portion of the fastening tool is pressed against a fastening substrate. Although this may protect against the inadvertent discharge of a fastener, it may not allow the user to properly align the fastening tool with the fastening substrate.

As may be appreciated, there exists a need in the art for a fastening tool configured to be more efficient and more user-friendly than existing fastening tools. The present invention addresses this particular need, as will be discussed in more detail below.

### BRIEF SUMMARY

The present invention specifically addresses and alleviates the above-referenced deficiencies associated with fastening tools of the prior art. More particularly, there is provided a fastening tool for use with a fastener. The fastening tool includes a tool body and a combustion housing disposed within the tool body. The combustion housing defines a combustion chamber within the combustion housing. A barrel is connected to the combustion housing and includes a barrel opening defining a longitudinal barrel axis. The barrel opening is sized and configured to receive the fastener. A power assembly is also connected to the tool body. The power assembly includes a power source, a power regulator, and a manual power control. The power source is configured to generate a power source signal. The power regulator is in electrical communication with the power source, and is configured to receive the power source signal and transmit a power regulator output having a power regulator output magnitude. The manual power control is in operative communication with the power regulator. The manual power control is configured to adjust the power regulator output magnitude.

The fastening tool also includes a spark generator connected to the combustion housing. The spark generator is in electrical communication with the power regulator. The spark generator is configured to generate a spark within the combustion chamber upon receipt of the power output from the power regulator. The spark includes a spark magnitude that varies in response to the power output magnitude. The fastening tool additionally includes a piston disposed within the combustion chamber. The piston is translatable along the longitudinal barrel axis and is engageable with the fastener to propel the fastener along the longitudinal barrel axis in response to combustion within the combustion chamber.

Another aspect of the invention includes a fastening tool for use with the fastener and a fastening substrate having a substrate contact surface. The fastening tool includes a tool body and a barrel connected to the tool body, as described above. A nose element is connected to the tool body and is moveable between a nose operational position and a nose safety position relative to the tool body. The nose element is biased towards the nose safety position. The nose element is also disposable against the substrate contact surface to move from the nose safety position toward the nose operational position upon movement of the barrel toward the substrate contact surface.

The fastening tool also includes a foot element connected to the tool body. The foot element is moveable between a foot operational position and a foot safety position relative to the tool body. The foot element is biased towards the foot safety position and is disposable against the substrate contact surface to move from the foot safety position toward the foot operational position upon movement of the barrel toward the substrate contact surface.

A firing control unit is in electrical communication with the nose element and the foot element. The firing control unit is configured to generate a firing signal when the nose and foot elements are in the respective nose and foot operational positions. A fastener propelling element is in electrical communication with the firing control unit. The fastener propelling element is configured to propel the fastener along the longitudinal barrel axis upon receipt of the firing signal.

A further aspect of the present invention includes a fastening tool configured to propel a fastener into a fastening substrate at a fastener velocity. The fastening tool includes a tool body and a barrel connected to the tool body. The barrel includes a barrel tip and a barrel opening defining a longitudinal barrel axis. The barrel opening is sized and configured to receive the fastener. A nose element is connected to the tool body and includes a nose contact portion. The nose element is disposable against the fastening substrate. The nose element may be configured to distribute pressure applied to the fastening substrate by the fastening tool. A first distance is defined between the nose contact portion and the barrel tip along the longitudinal barrel axis. A penetration control element is connected to the nose element and the tool body. The penetration control element is configured to move the nose contact portion relative to the barrel tip to vary the first distance. The fastener velocity increases as the first distance decreases, and vice versa.

An additional aspect of the invention includes a fastening tool for use with a fastener, a fastening substrate, and a fuel cell. The fastening substrate includes a substrate contact surface. The fuel cell includes a fuel cell body and a fuel cell nozzle. The fuel cell nozzle defines a fuel nozzle axis. The fuel cell nozzle is moveable between a fuel open position and a fuel closed position relative to the fuel body along the fuel nozzle axis. The fuel cell nozzle is biased towards the fuel closed position. The fuel cell is configured to discharge fuel when the fuel cell nozzle is in the fuel open position.

The fastening tool includes a tool body and a combustion assembly connected to the tool body. The combustion assembly includes a combustion housing defining a combustion chamber within the combustion housing. A barrel is connected to the combustion housing and defines a barrel opening having a longitudinal barrel axis. The barrel opening is sized and configured to receive the fastener. A piston is disposed within the combustion chamber and is translatable along the longitudinal barrel axis. The piston is engagable with the fastener to propel the fastener along the longitudinal barrel axis.

A fuel housing is connected to the tool body and includes a fuel chamber that is sized and configured to receive the fuel cell body. A fuel valve is connected to the fuel housing and is in fluid communication with the combustion chamber. The fuel valve is mechanically and fluidly engagable with the fuel cell nozzle.

A nose element is connected to the tool body and is moveable between a nose operational position and a nose safety position relative to the tool body. The nose element is biased towards the nose safety position and is disposable against the substrate contact surface to move the nose element from the nose safety position towards the nose operational position upon movement of the tool body towards the substrate contact surface. A fuel activation member is connected to the nose element and defines an activation longitudinal axis. The fuel activation member is translatable along the activation longitudinal axis relative to the fuel housing as the nose element moves between the nose safety and nose operational positions. The fuel activation member is engagable with the fuel cell body to move the fuel cell body relative to the fuel cell nozzle to dispose the fuel cell nozzle in the fuel open position when the nose element is in the nose operational position.

A further aspect of the present invention includes a fastening tool for use with a fastener and a fuel cell having a fuel cell body and a fuel cell nozzle. The fuel cell body defines a fuel cell longitudinal axis and a fuel cell maximum cross-sectional perimeter being orthogonal to the fuel cell longitudinal axis. The fastening tool includes a tool body and a combustion assembly connected to that tool body as described above. A fuel housing is connected to the tool body and defines a fuel housing longitudinal axis. The fuel housing includes a fuel wall disposed about the fuel housing longitudinal axis. The fuel wall includes a fuel wall minimum cross-sectional perimeter that circumscribes at least a portion of the fuel cell maximum cross-sectional perimeter. The fuel wall minimum cross-sectional perimeter is orthogonal to the fuel housing longitudinal axis. A fuel cradle is connected the fuel wall and includes a fuel cradle nozzle portion engageable with the fuel cell nozzle. The fuel cell nozzle is disposed in a fuel disposing position in response to engagement with the fuel cradle nozzle portion.

Various aspects of the present invention are directed toward a more user friendly fastening tool that may be adapted for use with various fastening materials. The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a top perspective view of a fastening tool constructed in accordance with an aspect of the present invention, the tool having a tool body including a head portion, handle portion, and rail portion;

FIG. 1A is an exploded view of a fastener rail and biasing member for loading fasteners into the fastening tool;

FIG. 2 is a top perspective view of the fastening tool shown in FIG. 1, the tool being rotated 180 degrees;

FIG. 3 is a top perspective view of the fastening tool shown in FIG. 2, the tool being rotated 90 degrees in one plane, and 90 degrees in another plane;

FIG. 4 is a sectional view of the fastening tool shown in FIGS. 1-3;

FIG. 5A is a block diagram showing a power control assembly for the fastening tool;

FIG. 5B is a block diagram showing a fuel control assembly for the fastening tool;

FIG. 6 is a block diagram showing a firing control for the fastening tool;

FIG. 7 is a top perspective view of the fastening tool with the handle and rail portions shown in phantom to illustrate a power housing and a fuel housing;

FIG. 7A illustrates an end view of the fuel housing illustrated in FIG. 7;

FIG. 8 is an exploded perspective view of a fuel cylinder and a fuel cradle;

FIG. 9 is an enlarged perspective view illustrating the fuel cylinder disposed within the fuel cradle along the rail portion of the tool body;

FIG. 10 is a sectional view of a nose portion of the fastening tool, the fastening tool having a barrel configured to receive a fastener, and a nose element;

FIG. 11 is a section view of the nose portion of the fastening tool shown in FIG. 10, wherein the distance between the nose element and the barrel is decreased;

FIG. 12 is a top perspective view illustrating a manual depth control for controlling movement of the nose element relative to the barrel; and

FIG. 13 is a top sectional view of the head portion of the fastening tool.

### DETAILED DESCRIPTION

Referring now to the drawings wherein the showings are for purposes of illustrating preferred embodiments of the present of the invention and not for purposes of limiting the same, the figures show a fastening tool 10 configured for use with a fastener 12. As used herein, a fastener 12 is a piece of hardware that joins at least two fastening substrates 14 together. The fastener 12 may include commonly used fastening hardware that is now known (e.g., a nail or screw) or later developed. The fastening substrate 14 may be any item that may be connected to another item. Fasteners 12 are commonly used in the construction industry to connect various fastening substrates 14 together. For instance, in the case of wood framing, the fastening substrate 14 is wood, whereas in the case of metal framing, the fastening substrate 14 is metal. Fasteners 12 are also commonly used to attach drywall to a frame. In that case, the fastening substrates 14 include the sheet of drywall and the frame. It is contemplated that the present invention may be used in connection with various other fastening substrates 14 known by those skilled in the art.

The fastening substrate 14 may define a substrate contact surface 16. It is contemplated that the fastening tool 10 is configured to propel a fastener 12 into the substrate contact surface 16 of the fastening substrate 14. For instance, in the case of framing construction, a fastening tool 10 is typically used to propel a nail into the framing material (e.g., wood or metal). However, the fastening tool 10 may be used in other applications that are known by those skilled in the art without departing from the spirit and scope of the present invention.

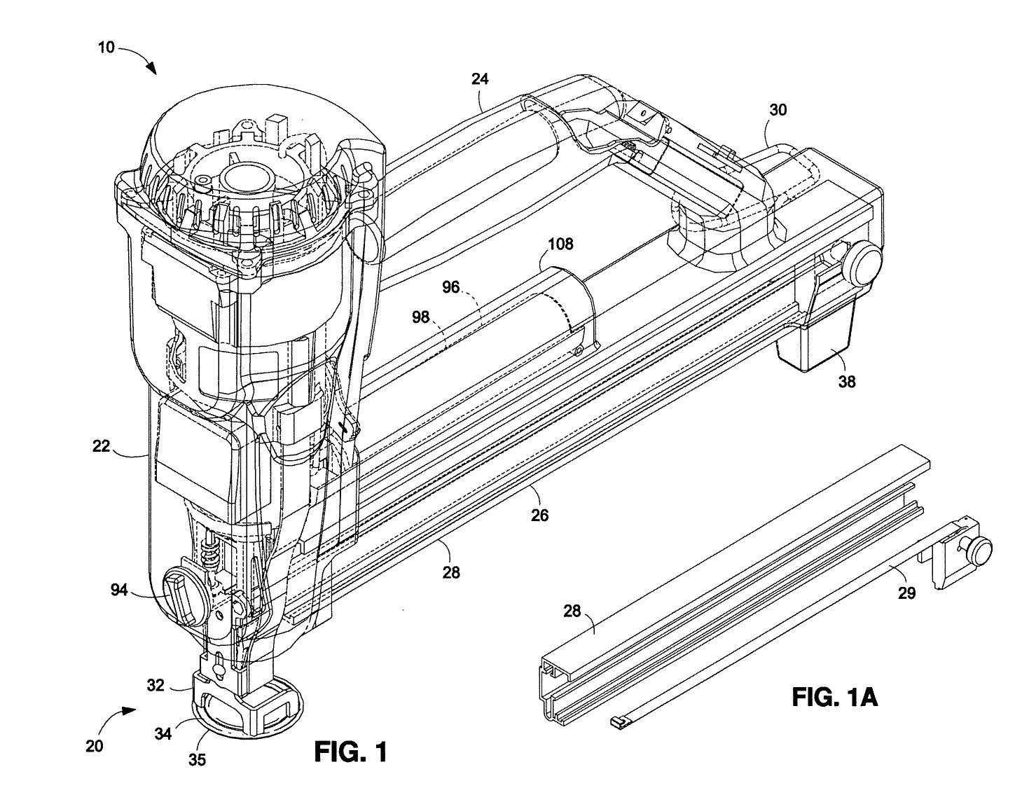

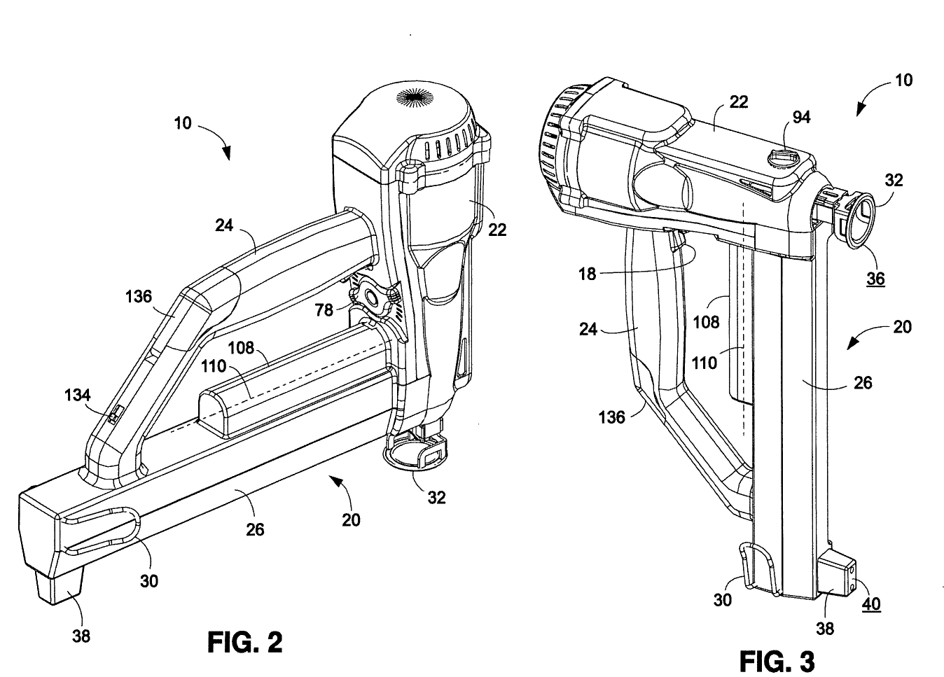

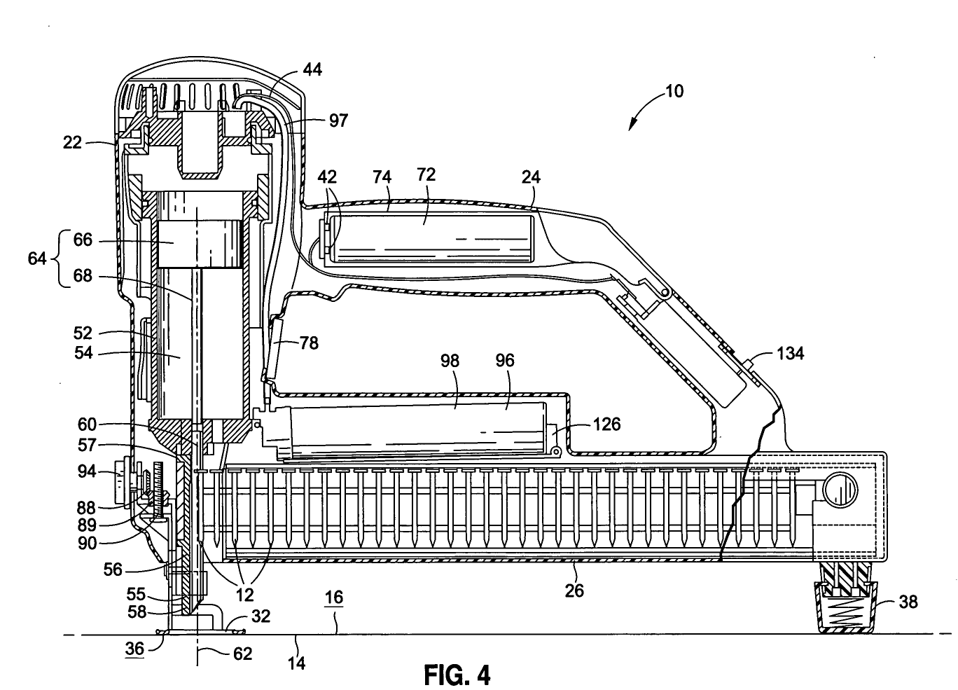

FIG. 1 shows a top perspective view of an embodiment of the fastening tool 10. The tool 10 includes a tool body 20 having a head portion 22, a handle portion 24 and a rail portion 26. The rail portion 26 may be configured to receive a plurality of fasteners 12, as best shown in FIG. 4. The fasteners 12 may be packaged into a magazine, clip, ribbon, or other fastener packaging used in the art. The fasteners 12 may be slidably received along a fastener rail 28 connected to the rail portion 26 of the tool body 20. A fastener biasing member 29, may bias the fasteners 12 along the fastener rail 28 toward the tool head portion 22. Therefore, as one fastener 12 is propelled out of the tool 10, another fastener 12 may be biased toward the tool head portion 22 and positioned to be propelled from the tool 10. The fastener biasing member 29 may be connected to the rail portion 26 of the tool 10, or alternatively, it may be included within the fastener packaging described above. It is also contemplated that the rail portion 26 may also include a rail hook 30 as shown in FIGS. 2 and 3. The rail hook 30 may be used to hang the tool 10 on a belt worn by the user, or to conveniently store the fastening tool 10 between uses.

The fastening tool 10 is configured to propel the fastener 12 toward a fastening substrate 14. Accordingly, various aspects of the present invention include a tool 10 having an internal combustion chamber for generating the force necessary to propel the fastener 12. Referring now to the embodiment depicted in FIG. 4, there is shown a fastening tool 10 having a combustion housing 52 disposed within the tool head portion 22. The combustion housing 52 defines a combustion chamber 54 within the combustion housing 52. A barrel 56 is connected to the combustion housing 52. The barrel includes a barrel opening 60 that is sized and configured to receive the fastener 12. The barrel opening 60 may define a U-shaped or semi-circular channel in which the fastener 12 is received. In this manner, a portion of the fastener 12 engages with the barrel 56. The fastener 12 is held in place within the barrel opening 60 in a loaded position. In this regard, the fastener 12 is in a position to be propelled from the tool 10. The barrel 60 also defines a longitudinal barrel axis 62. It is contemplated that the length and shape of the barrel 56 and barrel opening 60 may be sized and configured in various configurations by those skilled in the art. For instance, certain implementations of the tool 10 may include a fully enclosed barrel 56, much like a conventional gun. In that case, the barrel 56 would completely circumscribe the fastener 12.

The barrel 56 defines opposing first and second barrel end portions 55, 57. The first end portion 55 includes a barrel tip 58, while the second barrel end portion 57 is connected to the combustion housing 52. The barrel 56 and the combustion housing 52 may be integrated into a single piece of hardware. Alternatively, the barrel 56 may be detachably connected to the combustion housing 52. This may be desirable in order to clean and maintain the fastening tool 10, as described in more detail below.

The fastening tool 10 further includes a piston 64 disposed within the combustion chamber 54, as depicted in FIG. 4. The piston 64 includes a piston head portion 66 and a piston shaft portion 68. The perimeter of the piston head portion 66 is smaller than the inner perimeter of the combustion housing 52 to allow the piston to translate within the combustion housing 52. The piston 64 is moveable within the combustion chamber 54 along the longitudinal barrel axis 62 in response to combustion within the combustion chamber 54. As the piston 64 translates, the piston shaft portion 68 engages with the fastener 12 to propel the fastener 12 along the longitudinal barrel axis 62. In this manner, at least a portion of the piston shaft 68 translates within the barrel opening 60 to engage with the fastener 12.

Combustion is generated by introducing fuel and a spark into an air filled combustion chamber 54. The fuel may be provided by a fuel source 42 while the spark may be provided by a spark generator 48, which may include a conventional spark plug. The spark generator 48 may be connectable to a spark housing connected to the combustion housing 52. In this manner, the spark generator 48 may be removed from the spark housing 46 for routine maintenance thereof. The spark generator 48 may be positioned such that the spark is emitted into the combustion chamber 54. The spark housing 46 may include a spark fan to direct fuel into the combustion chamber 54.

According to one embodiment, the spark generator 48 is in electrical communication with a power assembly 70. The power assembly 70 includes a power source 72, a power regulator 76, and a manual power control 78. The power source 72 may include both internal and external power elements. For instance, an internal power element may include a battery, as shown in the drawings. The battery may be rechargeable to allow reuse thereof. An external power element may include a power cord that is connectable to an external power supply, such as a power outlet. It may be desirable to employ an internal power element to allow greater flexibility of the fastening tool 10. In other words, the range of motion of the tool 10 would not be restricted by the length of a power cord.

The power source 72 may be received within a power housing 74. The power housing 74 may include a pivotable power cover 136. The power housing 74 may include positive and negative electrical leads which are connectable to the power source 72. Electrical contacts 42 are disposed within the power housing 74. A battery 74 may be disposable within the power housing 74 in abutting contact with the electrical contacts 42. The electrical contacts 42 may be in electrical connection with the combustion housing 52. In this manner, an electrical connection 44 may extend between the electrical contacts 42 and the spark generator 48. The electrical connection may also extend to an On/Off switch 134 to enable a user to control the flow of power from the power source 72.

In the particular embodiment shown in the figures, the power housing 74 is located within the handle portion 24 of the tool body 20. The power housing 74 may be positioned to distribute the weight of the tool 10 to make the tool 10 more user friendly. This may be particularly helpful when the tool 10 is carried for long periods of time or when the tool 10 is held overhead during use. As shown, the power housing 74 is disposed within the handle portion 24 of the tool body 20. However, it is understood that the power housing 74 may be positioned at other locations of the tool body 20 without departing from the spirit and scope of the present invention.

The power source 72 is configured to generate a power source signal, such as a voltage. It is contemplated that the power source signal may be supplied at constant or variable power levels. If the power source 72 is a battery, the power source signal will likely be a constant voltage, such as six volts.

The tool 10 may also include an ON/OFF switch 134 in electrical communication with the power source 72. Therefore, when a power source 72 is inserted into the power housing 74 the ON/OFF switch 134 may control whether power is drained from the power source 72. In other words, simply placing the power source 72 into the power housing 74 may not automatically drain power from the power source 72. Rather, the tool 10 may be configured to require the ON/OFF switch to be in the ON position in order for a power source signal to be emitted from the power source 72. In this manner, the ON/OFF switch 134 protects against inadvertent draining of the power source 72. In one embodiment, the ON/OFF switch 134 may interrupt the positive lead from the power source 72.

It may be particularly beneficial to regulate the force applied to the fastener 12 when the tool 10 is used to propel fasteners 12 into different fastening substrates 14. For instance, a larger force will typically be needed to sufficiently propel the fastener 12 into a metal material compared to a wood material. Furthermore, certain pieces of wood are harder than others and may require a larger force to propel the fastener 12 into such wood pieces.

According to one aspect of the present invention, the propelling force may be varied by varying the size of the spark generated by the spark generator 48. As the size of the spark increases, the intensity of the ignition of the fuel in the combustion chamber 54 also increases, which results in a larger propelling force. Likewise, as the size of the spark decreases, the intensity of the fuel ignition decreases, resulting in a smaller propelling force. Therefore, by varying the size of the spark generated by the spark generator 48, the size of the force applied to the fastener 12 may be varied as desired.

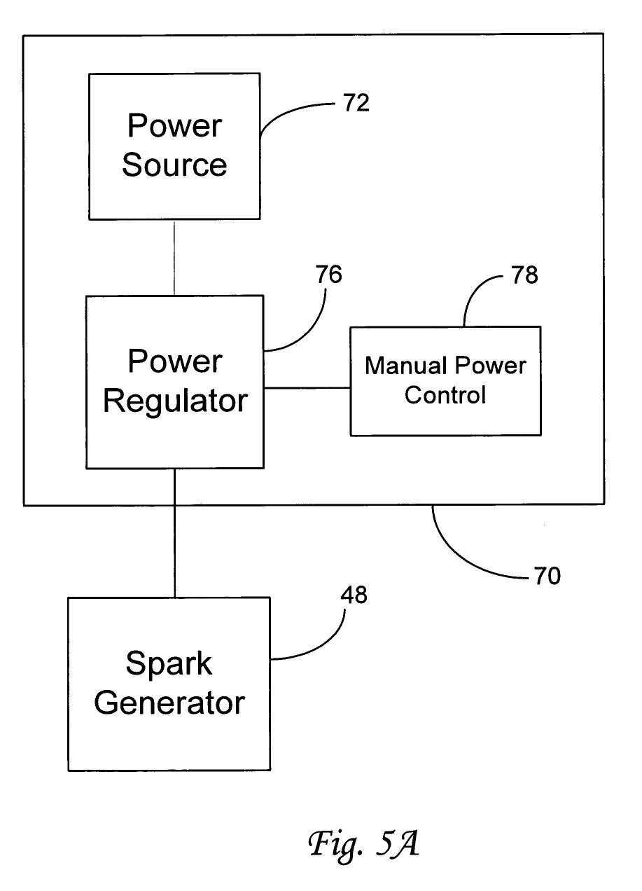

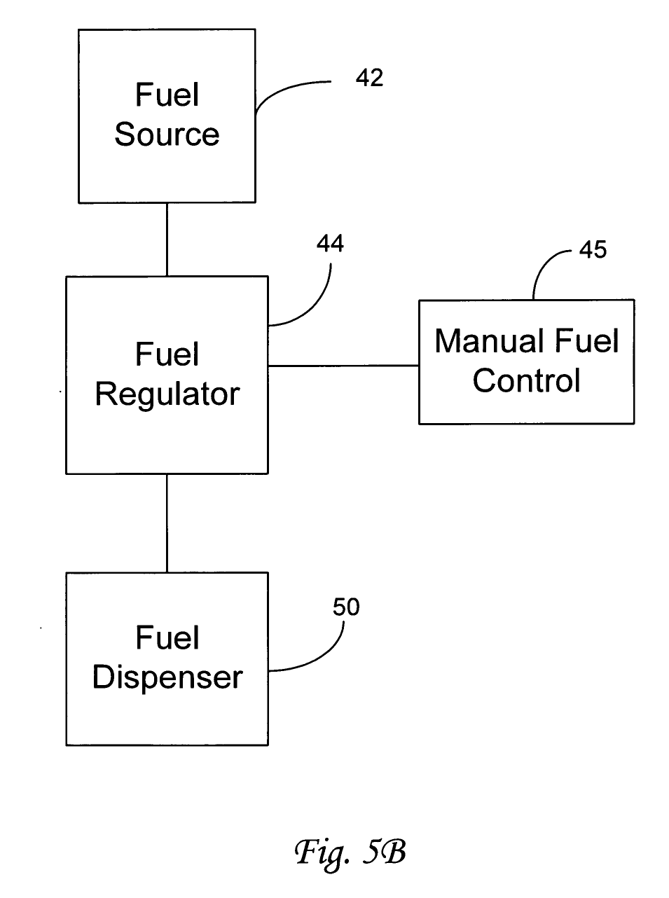

Consequently, one particular aspect of the invention relates to varying the amount of power communicated from the power source 72 to the spark generator 48 to vary the magnitude of the spark generated by the spark generator 48. FIG. 5A shows a schematic diagram of a system for varying the amount of power communicated to the spark generator 48. There is shown a power source 72 in electrical communication with a power regulator 76. The power regulator 76 is configured to receive the power source signal and transmit a power regulator output having a power regulator output magnitude. The power regulator output is subsequently communicated to the spark generator 48. The spark generator 48 is capable of generating a spark within the combustion chamber 54 upon receipt of the power regulator output.

By varying the power regulator output magnitude, the size of the spark generated by the spark generator 48 may be varied, which in turn, varies the size of the resultant combustion. Therefore, by regulating the power regulator output magnitude, the force applied to the fastener 12 may also be regulated.

The power regulator 76 may be in operative communication with a manual power control 78 that is configured to adjust the power regulator output magnitude. As depicted in FIG. 2, the manual power control 78 is a switch located on the exterior of the head portion 22 of the tool body 20. A user may turn the switch to vary the power regulator output magnitude. One particular implementation of the manual power control 78 allows a user to regulate the power regulator output magnitude to preset levels. In this manner, the manual power control 78 includes preset settings to control the power regulator output magnitude. For instance, the power source 72 may generate a power source signal that is substantially equal to a constant six volts. The power regulator 76 receives the six volts and outputs a power regulator output magnitude. In one embodiment, the manual power control 78 may control the power regulator 76 to vary the power regulator output magnitude by one-half volt increments. In the particular example of a six volt power source 72, the preset settings may be configured so that anywhere between three and six volts may be communicated to the spark generator 48 even though the power source 72 is supplying power at a constant six volts.

Although a particular embodiment including preset levels of power regulator output magnitudes is described, it is understood that the scope of the present invention is not limited thereto. Indeed, the power regulator 76 may be configured to vary the power as desired by the user. In other words, the power regulator 76 may vary the voltage in one volt, one half volt, or one third volt increments, or any other increment that may be desirable. Furthermore, it is also understood that the increments are not required to be equal. Therefore, one increment may be one half volt while another increment may be one third volts. It is additionally contemplated that the manual power control 78 may be configured to incrementally vary the power regulator output magnitude to any level desired by the user. In other words, the manual power control 78 may not have preset settings.

According to one embodiment, the power regulator 76 is a resistor in electrical communication with the power source 72 and the spark generator 48. The resistor is capable of receiving an input voltage from the power source 72 and outputting an output voltage that may differ from the input voltage. The output voltage may then be communicated to the spark generator 48 to generate the spark within the combustion chamber 54.

Although the above describes varying the combustion within the combustion chamber 54 by varying the magnitude of the spark, it is also contemplated that the combustion may also be varied by varying the amount of fuel introduced into the combustion chamber 54. As such, one aspect of the invention may include a fuel regulator 44 in fluid communication with a fuel source 42, as shown in FIG. 5B. The fuel regulator 44 may include a fuel regulator valve that controls the amount of fuel communicated into the combustion chamber 54 via a fuel dispenser 50. As more fuel is introduced into the combustion chamber 54, a larger combustion is generated. A fuel regulation switch may be in operative communication with the fuel regulator valve 44 to allow the user to manually control the amount of fuel discharged into the combustion chamber 54.

Another aspect of the invention may relate to ensuring the fastening tool 10 is properly positioned before a fastener 12 is discharged therefrom. As such, the tool 10 may include a nose element 32 connected to the tool body 20. The nose element 32 is disposable against the fastening substrate 14, which may include, but is not limited to wood, metal or drywall as described above. As shown, the nose element 32 includes a nose contact portion 34 which abuts the fastening substrate 14.

The nose contact portion 34 depicted in the drawings is configured in the shape of a circular ring 35. The circular nose contact portion 34 may be concentrically disposed about the longitudinal barrel axis 62. The circular configuration of the nose contact portion 34 distributes the pressure of the tool 10 applied to the fastening substrate 14 so as to mitigate damaging the fastening substrate 14. This may be particularly beneficial when the fastening tool 10 is used in connection with drywall. The fastening tool 10 contacts the drywall before a fastener 12 is propelled therein. Therefore, distributing the pressure applied by the fastening tool 10 to the drywall mitigates the damage which may be created by the pressure. Although the above describes a particular embodiment of the nose contact portion 34 as a circular ring 35, it is understood that the nose contact portion 34 may be sized and configured to be any shape as desired by the user.

In one embodiment, the nose element 32 is moveable between a nose operational position and a nose safety position relative to the tool body 20 as the fastening tool 10 is pressed toward the fastening substrate 14. In the embodiment shown in the figures, the nose element 32 is received within the tool body head portion 22 as it moves from the nose safety position toward the nose operational position. It is contemplated that the nose element 32 is biased towards the nose safety position. In this manner, the biasing force must be overcome in order to move the nose element 32 from the nose safety position toward the nose operational position.

In operation, the nose element 32 is disposable against the substrate contact surface 16 before a fastener 12 is propelled from the tool 10. With the nose element 32 disposed against the substrate contact surface 16, the user pushes the tool body 20 toward the substrate contact surface 16, which in turn causes the barrel 56 to move toward the substrate contact surface 16. Since the nose element 32 is already disposed against the substrate contact surface 16, and the tool body 20 is pushed toward the substrate contact surface 16, the nose element 32 and tool body 20 move relative to each other. More specifically, the nose element 32 moves from the nose safety position towards the nose operational position.

In addition to a nose element 32, the tool 10 may also include a foot element 38 connected to the tool body 20. As illustrated in the drawings, the foot element 38 is connected to the rail portion 26 of the tool body 20. The foot element 38 is moveable between a foot operational position and a foot safety position relative to the tool body 20. In the particular embodiment depicted, the foot element 38 is received within the rail portion 26 as the foot element 38 moves between the foot safety position and the foot operational position. The foot element 38 may be biased towards the foot safety position.

Similar to the nose element 32, the foot element 38 is also disposable against the substrate contact surface 16 during operation of the fastening tool 10. When the foot element 38 is disposed against the substrate contact surface 16, a user may press the tool body 20 toward the substrate contact surface 16, which in turn causes the barrel 56 to move toward the substrate contact surface 16. Such movement causes the foot element 38 to move relative to the tool body 20. More specifically, the foot element 38 moves from the foot safety position toward the foot operational position.

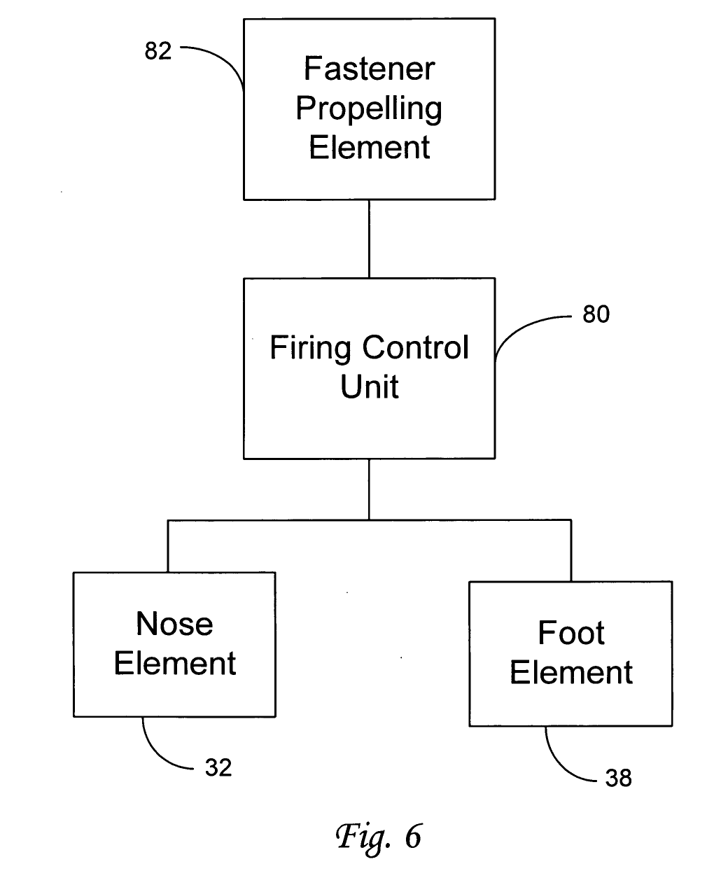

Referring now to FIG. 6, the fastening tool 10 may also include a safety mechanism configured to prevent inadvertent firing of a fastener 12. In one embodiment, the fastening tool 10 includes a firing control unit 80 configured to generate a firing signal. The fastening tool 10 may be configured to propel the fastener 12 in response to generation of the firing signal. Therefore, if no firing signal is generated, the fastener 12 may not be fired.

According to one aspect of the invention, the nose element 32 is in communication with the firing control unit 80. As such, the firing control unit 80 may be configured to generate the firing signal when the nose element 32 is in the nose operational position. According to another aspect of the invention, the foot element 38 is in communication with the firing control unit 80. Consequently, the firing control unit 80 may be configured to generate the firing signal when the foot element 38 is in the foot operational position.

It is also contemplated that the firing control unit 80 is in electrical communication with both the nose and foot elements 32, 38. In this manner, the firing control unit 80 is configured to generate a firing signal when both of the nose and foot elements 32, 38 are in the respective nose and foot operational positions. As such, both the nose and foot elements 32, 38 may be required to be placed against the substrate contact surface 14 and disposed in the nose and foot operational positions, respectively, in order to generate a firing signal. Therefore, if only one of the nose and foot elements 32, 38 are in one of the respective nose and foot operational positions, the firing control unit 80 may not generate the firing signal.

According to another aspect of the invention, the nose and foot elements 32, 38 are configured to ensure the fastener 12 is propelled toward the fastening substrate 14 at the desired angle. For instance, in the case of drywall, if the head of the fastener 12 extends beyond the substrate contact surface 16, the finished construction product may not meet certain industry standards. Therefore, it may be desirable to propel the fastener 12 orthogonally into the substrate contact surface 16, so that portions of the fastener 12 do not extend beyond the substrate contact surface 16 in violation of certain industry codes.

Therefore, the nose and foot elements 32, 38 may include nose and foot contact surfaces 36, 40 respectively, which are disposable against the fastening substrate 14 to properly align the longitudinal barrel axis 62 with respect to the substrate contact surface 16. In one embodiment, the nose and foot contact surfaces 36, 40 are configured to dispose the longitudinal barrel axis 62 in a substantially orthogonal orientation with respect to the substrate contact surface 16. One aspect of the present invention may include nose and foot contact surfaces 36, 40 disposed in co-planar relation with respect to each other. For instance, both the nose and foot contact surfaces 36, 40 may be orthogonal to the longitudinal barrel axis 62.

In one particular implementation of the invention, the nose and foot elements 32, 38 each include nose and foot sensors, respectively, configured to sense when the nose and foot elements 32, 38 are in the respective nose and foot operational positions. The nose and foot sensors may be in communication with the firing control unit 80. As such, a signal may be sent from the nose sensor to the firing control unit 80 with the nose element 32 is in the nose operational position. Likewise, a signal may be sent from the foot sensor to the firing control unit 80 when the foot element 38 is in the foot operational position.

A fastener propelling element 82 may be in electrical communication with the firing control unit 80. The fastener propelling element 82 is configured to propel the fastener 12 along the longitudinal barrel axis 62 upon receipt of the firing signal. In one embodiment, the fastener propelling element 82 includes the piston 64, combustion housing 52 and the spark generator 48. Those elements collectively propel the fastener 12 along the longitudinal barrel axis 62. However, it is understood that the fastener propelling element 82 may include other propelling means known by those skilled in the art, such as compressed air.

As previously mentioned, the fastening tool 10 may be used to propel fasteners 12 into various materials. As can be appreciated, in order for the fastener 12 to be properly disposed within a particular material, the fastener 12 may be required to enter a harder material with more momentum than is required to enter a softer material in order to penetrate the material to an appropriate fastening depth. As used herein, a fastening depth is equal to the depth required to place the shank portion of the fastener 12 into the material and to dispose the fastener head substantially flush with the substrate contact surface 16.

If the mass of the fastener 12 is constant, one way to vary the momentum of the fastener 12 is to vary the velocity at which the fastener 12 enters the substrate contact surface 16. Furthermore, if the fastener 12 is propelled with a substantially constant force, the velocity of the fastener 12 may be varied by varying the distance which the fastener 12 travels before entering the fastening substrate 14. In particular, as the fastener 12 travels, friction and drag forces may act on the fastener 12 which slow it down. By increasing the distance which the fastener 12 travels, more friction can act on the fastener 12 before it enters the fastening substrate 14.

Therefore, one aspect of the present invention includes a penetration control element 84 configured to vary the distance which the fastener 12 travels before entering the fastening substrate 14. As such, the penetration control element 84 may be configured to vary the distance between the nose element 32 and the point at which the fastener 12 is propelled toward the substrate contact surface 16.

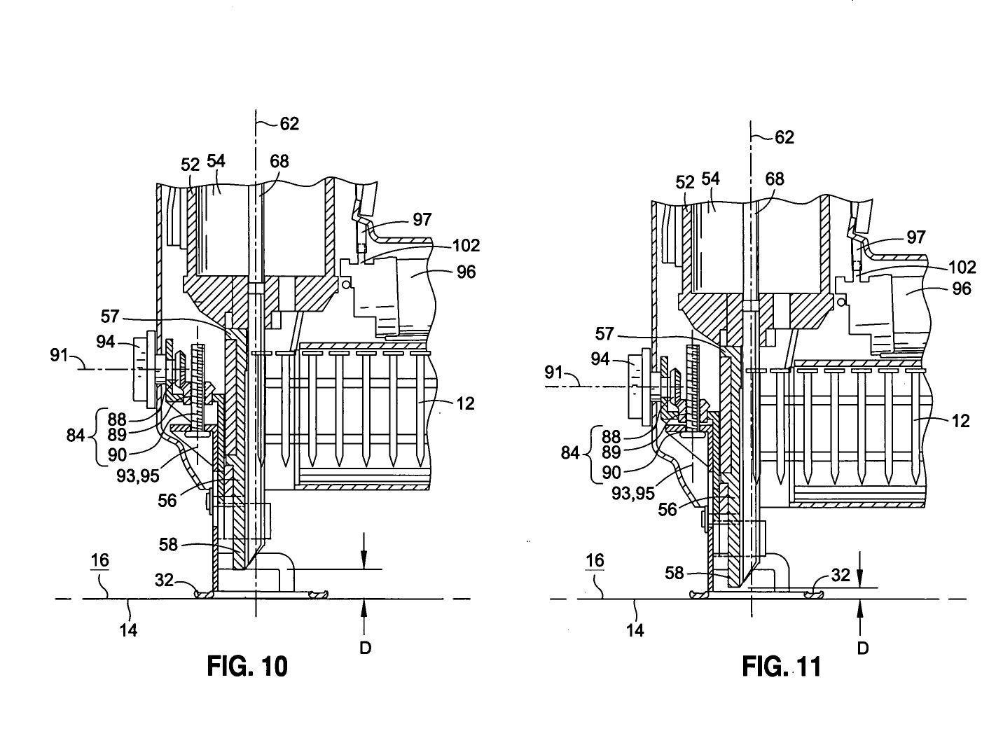

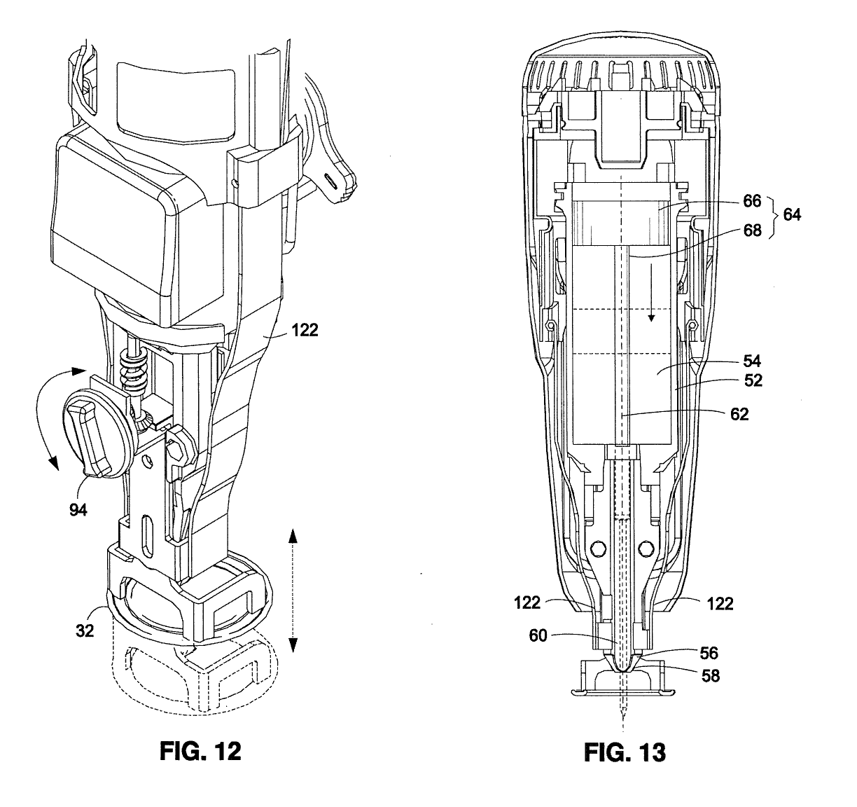

In one particular embodiment, the penetration control element 84 is connected to the nose element 32 and the tool body 20. Referring now to FIGS. 10-11, there is shown a sectional view of the nose portion of the fastening tool 10 disposed against a substrate contact surface 16. The penetration control element 84 is configured to move the nose contact portion 34 relative to the barrel tip 58 to vary a first distance “D.” As used herein, the first distance D is defined by the distance between the nose contact portion 34 and the barrel tip 58 along the longitudinal barrel axis 62. As the first distance D decreases, the fastener velocity increases; likewise as the first distance D increases the fastener velocity decreases. Therefore, the first distance D may be varied to alter the fastener velocity.

It is contemplated that the fastening tool 10 may be configured such that when the first distance D is at its minimum, the fastener 12 may enter the fastening substrate 14 while still being propelled by the fastening tool 10. In this manner, the friction and drag forces referred to above may not slow the fastener 12 down because it is still being acted on by the tool 10. Alternatively, when the first distance D is at its maximum, the fastening tool 10 may have completed its exertion of the propelling force upon the fastener 12. As such, the fastener begins to slow down as it travels toward the fastening substrate 14. Therefore, by altering the first distance D, the velocity at which the fastener 12 enters the fastening substrate 14 may also be varied.

The penetration control element 84 may include preset settings corresponding to various materials. In other words, each preset setting may relate to a first distance D for a particular material. For instance, there may be a specific setting for a metal stud, a hardwood stud and a softwood stud. The user may alter the setting depending on the type of material the fastener 12 is being propelled into.

A particular implementation of the penetration control element 84 includes a primary gear 88 and a secondary gear 89. The primary gear 88 is rotatable about a primary rotation axis 91 and the secondary gear 89 is rotatable about a secondary rotation axis 93. As shown, the primary and secondary rotation axes 91, 93 are orthogonal to each other. The secondary gear 89 is engaged with a depth control shaft 90 defining a shaft translation axis 95. The depth control shaft 90 is connected to the nose element 32. The depth control shaft 90 includes external threads which engage with internal threads on the secondary gear 89. Consequently, as the secondary gear 89 rotates, the shaft 90 translates along the shaft translation axis 95.

A manual depth control 94 may be connected to the primary gear 88. The manual depth control 94 is configured to allow a user to control rotation of the gear 88. Consequently, if the user wants to alter the first distance D, the user may utilize the manual depth control 94 to rotate the gear 88 and vary the first distance D. As shown, the manual depth control 94 is positioned on the exterior of the tool head portion 22.

As previously mentioned, the fastening tool 10 may be fuel powered. In this manner, a fuel source provides fuel to operate the fastening tool 10. It is contemplated that fuel may be provided by a fuel cell 96. Fuel cells 96 are commonly used in conventional nail fasteners. A fuel that is commonly used is hydrocarbon fuel; however, other fuels known by those skilled in the art may also be used. The fuel cells 96 typically include a fuel cell body 98 and a fuel cell nozzle 102. The fuel cell body 98 defines a fuel cell longitudinal axis 100 and a fuel cell maximum cross-sectional perimeter 106 that is orthogonal to the fuel cell longitudinal axis 100. The fuel cell nozzle 102 defines a fuel nozzle axis 104. The fuel cell nozzle 102 is movable between a fuel open position and fuel closed position relative to the fuel cell body 98 along the fuel nozzle axis 104. The fuel cell nozzle 102 is biased towards the fuel closed position. The fuel cell 96 is configured to discharge fuel when the fuel cell nozzle 102 is in the fuel open position. In one embodiment, the fuel cell 96 is pressurized so as to discharge fuel when the fuel cell nozzle 102 is in the fuel open position.

The fastening tool 10 may include a fuel housing 108 connected to the tool body 20. In the embodiment illustrated in the drawings, the fuel housing 108 is disposed along the rail portion 26 and abuts the head portion 22 of the tool body 20. However, it is understood that the position of the fuel housing 108 is not limited thereto. For instance, other embodiments may include a fuel housing 108 disposed within the handle portion 24 of the tool body 20. The fuel housing 108 includes a fuel chamber 116 that is sized and configured to receive the fuel cell body 98.

The fuel housing 108 defines a fuel housing longitudinal axis 110. A fuel wall 112 is disposed about the fuel housing longitudinal axis 110. The fuel wall 112 may be semi-cylindrical in shape; however, other shapes may be used without departing from the spirit and scope of the present invention. For instance, if the fuel cell 98 defines a rectangular cross section, it may be beneficial for the fuel wall 112 to be rectangular in shape. The fuel wall 112 includes a minimum cross-sectional perimeter 114 that is orthogonal to the fuel housing longitudinal axis 110. When the fuel cell 96 is placed within the fuel housing 108, the fuel wall minimum cross-sectional perimeter 114 circumscribes at least a portion of the fuel cell maximum cross-sectional perimeter 106. In this manner, various implementations of the present invention may include a fuel wall 112 that completely circumscribes the fuel cell 96. However, other configurations of the fuel wall 112 may only partially circumscribe the fuel cell 96.

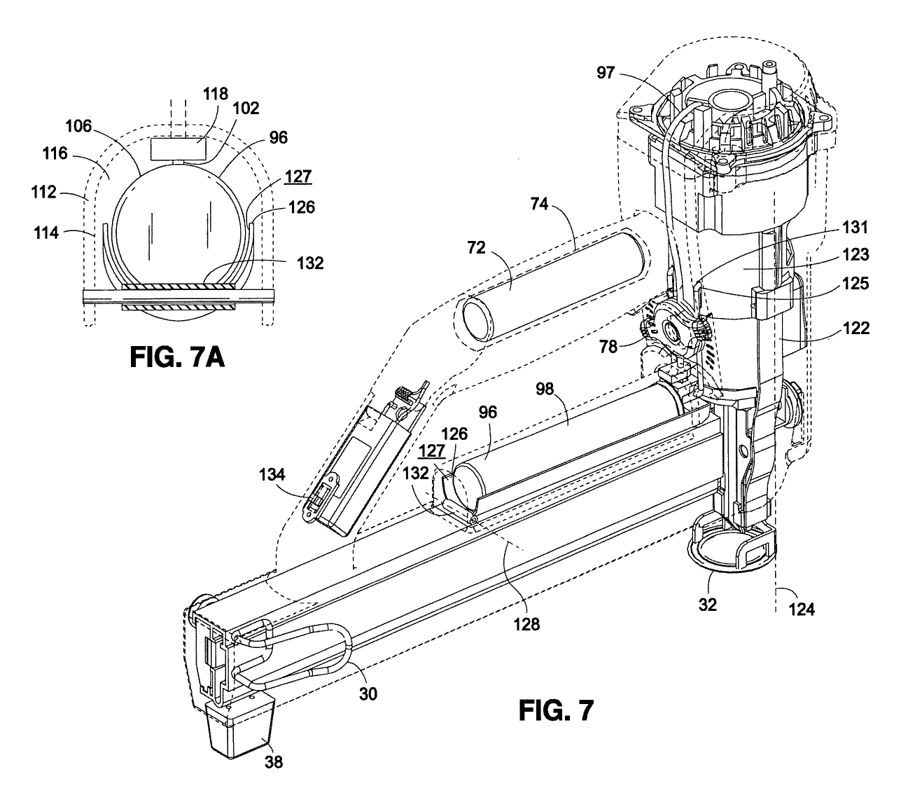

Referring now to FIGS. 7-9, one embodiment of the fuel housing 108 includes a fuel cradle 126 defining a cradle contact surface 127 and a fuel cradle longitudinal axis 133. The fuel cradle 126 is sized and configured to receive a fuel cell 96. As shown in FIG. 7 the fuel cradle 126 extends along the bottom portion of the fuel housing 108. The fuel cradle 126 pivots about a fuel cradle axis 128 relative to the tool body 20 between a fuel activation position and a fuel deactivation position, as described in more detail below. The fuel cradle 126 includes a fuel cradle nozzle portion 129 that is engagable with the fuel cell nozzle 102. As a fuel cell 96 is inserted into the fuel housing 108 the fuel cradle nozzle portion 129 engages with the fuel cell nozzle 102 to dispose the fuel cell nozzle 102 in a fuel disposing position. When the fuel cell nozzle 102 is in a fuel disposing position, the fuel cell nozzle 102 is aligned with a fuel valve 118 connected to the fuel wall 112. When the fuel cell nozzle 102 is fluidly engaged with the fuel valve 118, fuel may be communicated between the fuel cell 96 and a fuel line 97 via the fuel valve 118. However, as discussed above, the fuel cell 96 is configured to discharge fuel only when the fuel cell nozzle 102 is in the fuel open position. Consequently, the fuel housing 108 may be configured to dispose the fuel cell 96 in the fuel open position when the fuel cradle 126 is in the fuel activation position. Furthermore, the fuel cell nozzle 102 may be in the fuel closed position when the fuel cradle 126 is in the fuel deactivation position.

In many existing fastening tools 10 that employ the use a fuel cell 96, it tends to be very difficult to align the fuel cell nozzle 102 with the fuel valve 118 because there is very little space to maneuver the fuel cell 96 once it is inserted into the fuel housing 108. The fuel cradle nozzle portion 129 of the present invention mitigates this problem by aligning the fuel cell nozzle 102 with the fuel valve 118 before the fuel cell 96 is completely inserted within the fuel housing 108. In this regard, the fuel cell nozzle 102 may be aligned with the fuel cradle nozzle portion 129 in order for the fuel cell 96 to be received by the fuel cradle 126.

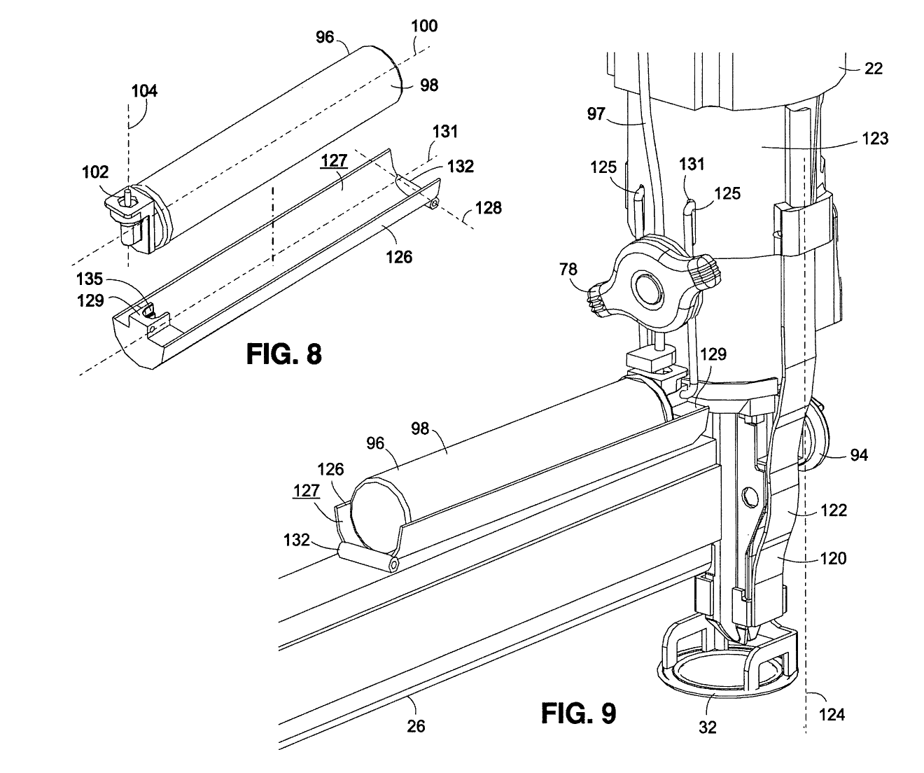

In the embodiment depicted in FIG. 8, the fuel cradle nozzle portion 129 includes a nozzle cavity 135 extending downwardly into the fuel cradle nozzle portion 129. The nozzle cavity 135 is sized and configured to receive the nozzle 102 of the fuel cell 96. In this manner, the engagement of the fuel cell nozzle 102 with the nozzle cavity 135 effortlessly aligns the fuel nozzle 102 with the fuel valve 118.

An additional aspect of the present invention includes a fuel activation mechanism to dispose the fuel cell nozzle 102 in the fuel open position. In the embodiment shown in FIG. 7, the fastening tool 10 includes a fuel activation member 120 connected to the nose element 32. The fuel activation member 120 defines an activation longitudinal axis 124 along which the fuel activation member 120 translates. Translation of the fuel activation member 120 is achieved when the nose element 32 moves between the nose safety position and nose operational positions as described above. The fuel activation member 120 is engagable with the fuel cell 96 to move the fuel cell 96 relative to the fuel cell nozzle 102 to dispose the fuel cell nozzle 102 in the fuel open position when the nose element 32 is in the nose operational position.

In the particular implementation shown in FIG. 7, the fuel activation member 120 includes a fuel activation rod 122 extending along a portion of the head portion 22 of the tool body 20. The fuel activation rod 122 is engaged with a fuel activation cylinder 123 disposed within the head portion 22. It is contemplated that the fuel activation cylinder 123 may be concentrically disposed about the barrel longitudinal axis 62. The fuel activation cylinder 123 may include one or more cylinder slots 131. As shown in FIG. 7 the fuel activation cylinder 123 includes a pair of cylinder slots 131. A fuel activation hook 125 engages with the cylinder slots 131 and is connected to the fuel cradle 126. Therefore, when the nose element 32 is disposed in the nose operational position, the fuel activation rod 122 translates along the activation longitudinal axis 124 along with the fuel cylinder 123. As the fuel cylinder 123 translates, the fuel activation hook 125 engaged in the cylinder slots 131 also translates along the activation longitudinal axis 124. Movement of the fuel activation hook 125 also moves the fuel cradle 126. More specifically, the fuel cradle 126 is caused to pivot between the fuel deactivation position toward the fuel activation position. Therefore, movement of the fuel activation member 120 causes the fuel cell nozzle 102 to move from the fuel closed position into the fuel open position to fluidly engage the fuel cell nozzle 102 with the fuel valve 118.

Given the complex nature of the fastening tool 10, it is understood that routine maintenance is very important to maintain operability of the tool 10. A small amount of dirt or dust may interrupt operation of the tool 10. Therefore, it is contemplated that the tool 10 may be configured to be easily disassembled for maintenance. As such, the various elements described herein may be detachably connected to each other to easily allow routine maintenance of the tool 10.

Furthermore, it may be difficult to determine when the tool 10 is ready for maintenance. Therefore, one embodiment includes a maintenance control unit that is electrically connectable with the power source 72. The maintenance control unit is configured to count of the number of fasteners 12 propelled by the fastening tool 10 since the last maintenance was performed on the tool 10. When a specified number of fasteners 12 have been discharged, routine maintenance may be suggested for that tool 10. A maintenance indicator may be in electrical communication with the maintenance control unit. The maintenance control indicator may include a light which may illuminate when maintenance is needed. Alternatively, the light may illuminate one color when maintenance is not required and another color when maintenance is required. Moreover, a maintenance alarm may generate a audio signal to alert the user that maintenance is required.

Another embodiment of the maintenance indicator is a maintenance display that is disposed on the tool body. The maintenance display conveniently shows the number of fasteners 12 that have been shot by the tool 10. The maintenance display may also be in electrical communication with the power source 72 to display the amount of power left in the power source 72. Therefore, when the power source 72 is close to being drained, a user can simply insert a fully charged power source 72 and avoid unwanted interruption of the fastening tool 10.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A fastening tool for use with a fastener, the fastening tool comprising:
a tool body;
a combustion housing connected to the tool body, the combustion housing defining a combustion chamber within the combustion housing;
a barrel connected to the combustion housing, the barrel having a barrel opening defining a longitudinal barrel axis, the barrel opening being sized and configured to receive the fastener;
a power assembly connected to the tool body, the power assembly including:
a power source configured to generate a power source signal;
a power regulator in electrical communication with the power source, the power regulator being configured to receive the power source signal and transmit a power regulator output having a power regulator output magnitude; and
a manual power control in operative communication with the power regulator, the manual power control being configured to adjust the power regulator output magnitude;
a spark generator connected to the combustion housing, the spark generator being in electrical communication with the power regulator, the spark generator being configured to generate a spark within the combustion chamber upon receipt of the power output from the power regulator, the spark having a spark magnitude that varies in response to the power output magnitude; and
a piston disposed within the combustion chamber, the piston being translatable along the longitudinal barrel axis, the piston being engagable with the fastener to propel the fastener along the longitudinal barrel axis in response to combustion within the combustion chamber.

2. The fastening tool as recited in claim 1 wherein the manual power control is configured to adjust the power regulator output magnitude to preset levels.

3. The fastening tool as recited in claim 1 wherein the power regulator is a resistor.

4. A fastening tool for use with a fastener and a fastening substrate having a substrate contact surface, the fastening tool comprising:
a tool body;
a barrel connected to the tool body, the barrel having a barrel opening defining a longitudinal barrel axis, the barrel opening being sized and configured to receive the fastener;
a nose element connected to the tool body, the nose element being moveable between a nose operational position and a nose safety position relative to the tool body, the nose element being biased towards the nose safety position, the nose element being disposable against the substrate contact surface to move from the nose safety position toward the nose operational position upon movement of the barrel toward the substrate contact surface;
a foot element connected to the tool body, the foot element being moveable between a foot operational position and a foot safety position relative to the tool body, the foot element being biased towards the foot safety position, the foot element being disposable against the substrate contact surface to move from the foot safety position toward the foot operational position upon movement of the barrel toward the substrate contact surface;
a firing control unit in electrical communication with the nose element and the foot element, the firing control unit being configured to generate a firing signal when the nose and foot elements are in the respective nose and foot operational positions; and
a fastener propelling element in electrical communication with the firing control unit, the fastener propelling element being configured to propel the fastener along the longitudinal barrel axis upon receipt of the firing signal.

5. The fastening tool as recited in claim 4, wherein the nose tip defines a nose contact surface and the foot element defines a foot contact surface being co-planar with the nose contact surface.

6. The fastening tool as recited in claim 4, wherein the nose element is moveable in a direction being parallel to the longitudinal barrel axis.

7. The fastening tool as recited in claim 4, wherein the nose element is translatably connected to the tool body.

8. The fastening tool as recited in claim 4, wherein the foot element is translatably connected to the tool body.

9. A fastening tool configured to propel a fastener into a fastening substrate at a fastener velocity, the fastening tool comprising:
a tool body;
a barrel connected to the tool body, the barrel having a barrel tip and a barrel opening defining a longitudinal barrel axis, the barrel opening being sized and configured to receive the fastener;
a nose element connected to the tool body, the nose element having a nose contact portion being disposable against the fastening substrate, the nose element being sized and configured to distribute pressure applied to the fastening substrate by the fastening tool, a first distance being defined between the nose contact portion and the barrel tip along the longitudinal barrel axis; and
a penetration control element connected to the nose element and the tool body, the penetration control element being configured to move the nose contact portion relative to the barrel tip to vary the first distance.

10. The fastening tool as recited in claim 9, wherein the penetration control element includes:
a primary gear being rotatable about a primary gear axis;
a secondary gear engaged with the primary gear, the second gear being rotatable about a secondary gear axis; and
a shaft connected to the nose element and engaged with the secondary gear, the shaft defining a shaft longitudinal axis, the shaft being translatable along the shaft longitudinal axis in response to rotation of the secondary gear.

11. The fastening tool as recited in claim 10, wherein the primary gear axis is orthogonal to the secondary gear axis.

12. The fastening tool as recited in claim 10, wherein the primary gear axis is orthogonal to the shaft longitudinal axis.

13. The fastening tool as recited in claim 10 wherein the secondary gear circumferentially engages the shaft.

14. The fastening tool as recited in claim 9 wherein the nose element is defines a circular shape.

15. A fastening tool for use with a fastener, a fastening substrate, and a fuel cell, the fastening substrate having a substrate contact surface, the fuel cell having a fuel cell body and a fuel cell nozzle, the fuel cell nozzle defining a fuel nozzle axis, the fuel cell nozzle being moveable between a fuel open position and a fuel closed position relative to the fuel body, the fuel cell nozzle being biased towards the fuel closed position, the fuel cell being configured to discharge fuel when the fuel cell nozzle is in the fuel open position, the fastening tool comprising:
a tool body;
a combustion assembly connected to the tool body, the combustion assembly including:
a combustion housing defining a combustion chamber within the combustion housing;
a barrel connected to the combustion housing, the barrel having a barrel opening defining a longitudinal barrel axis, the barrel opening being sized and configured to receive the fastener; and
a piston disposed within the combustion chamber, the piston being translatable along the longitudinal barrel axis, the piston being engageable with the fastener to propel the fastener along the longitudinal barrel axis;
a fuel housing connected to the tool body, the fuel housing having a fuel chamber being sized and configured to receive the fuel cell body;
a fuel valve connected to the fuel housing and in fluid communication with the combustion chamber, the fuel valve being mechanically and fluidly engageable with the fuel cell nozzle;
a nose element connected to the tool body, the nose element being moveable between a nose operational position and a nose safety position relative to the tool body, the nose element being biased towards the nose safety position, the nose element being disposable against the substrate contact surface to move the nose element from the nose safety position towards the nose operational position upon movement of the tool body toward the substrate contact surface; and
an fuel activation member connected to the nose element, the fuel activation member defining an activation longitudinal axis, the fuel activation member being translatable along the activation longitudinal axis relative to the fuel housing as the nose element moves between the nose safety and nose operational positions, the fuel activation member being engagable with the fuel cell to move the fuel cell relative to the fuel cell nozzle to dispose the fuel cell nozzle in the fuel open position when the nose element is in the nose operational position.

16. The fastening tool as recited in claim 15 wherein the fuel activation member includes an elongate fuel rod connected to the nose element.

17. The fastening tool as recited in claim 15 wherein the activation longitudinal axis is parallel to the longitudinal barrel axis.

18. A fastening tool for use with a fastener and a fuel cell having a fuel cell body and a fuel cell nozzle, the fuel cell body defining a fuel cell longitudinal axis and a fuel cell maximum cross sectional perimeter being orthogonal to the fuel cell longitudinal axis, the fastening tool comprising:
a tool body;
a combustion assembly connected to the tool body, the combustion assembly including:
a combustion housing defining a combustion chamber within the combustion housing;
a barrel connected to the combustion housing, the barrel defining a longitudinal barrel axis, the barrel being sized and configured to receive the fastener; and
a piston disposed within the combustion chamber, the piston being translatable along the longitudinal barrel axis, the piston being engageable with the fastener to propel the fastener along the longitudinal barrel axis; and
a fuel housing connected to the tool body, the fuel housing defining a fuel housing longitudinal axis, the fuel housing including:
a fuel wall disposed about the fuel housing longitudinal axis, the fuel wall having a fuel wall minimum perimeter that circumscribes at least a portion of the fuel cell maximum cross sectional perimeter, the fuel wall minimum cross sectional perimeter being orthogonal to the fuel housing longitudinal axis;
a fuel valve connected to the fuel wall, the fuel valve being in fluid communication with the fuel chamber and fluidly connectable with the fuel cell nozzle when the fuel nozzle is in a fuel disposing position; and
a fuel cradle connected to the fuel wall, the fuel cradle having a fuel cradle nozzle portion engagable with the fuel cell nozzle, the fuel cell nozzle being disposed in the fuel disposing position in response to engagement with the fuel cradle nozzle portion.

19. The fastening tool as recited in claim 18 wherein the fuel cradle nozzle portion includes a nozzle cavity.

20. The fastening tool as recited in claim 18 wherein the fuel cradle is pivotable about a cradle pivot axis relative to the fuel wall.
